(19) United States
(12) Patent Application Publication
(10) Pub. No.: US 2025/0296260 A1
(43) Pub. Date: Sep. 25, 2025

(54) SHAVING CARTRIDGE ASSEMBLY

(71) Applicant: The Gillette Company LLC, Boston, MA (US)

(72) Inventors: Robert Harold Johnson, Hingham, MA (US); Jeffrey Michael Mitrou, Windham, NH (US)

(21) Appl. No.: 19/087,769

(22) Filed: Mar. 24, 2025

Related U.S. Application Data
(60) Provisional application No. 63/569,495, filed on Mar. 25, 2024.

(51) Int. Cl. B26B 21/52; B26B 21/08; B26B 21/40

(52) U.S. Cl. CPC B26B 21/521; B26B 21/08; B26B 21/4012

(57) ABSTRACT

In another aspect, the invention features, in general a shaving cartridge assembly with a housing having a circular appendage defining a cavity extending through the housing. A shaving surface is mounted to the housing. A washer is mounted over the circular appendage and onto a flange of the housing. The washer is a ferromagnetic metal.

### FIELD OF THE INVENTION

The present invention relates to shaving razors and more particularly to shaving razor systems that have a shaving cartridge assembly releasably mounted to a handle.

### BACKGROUND OF THE INVENTION

Shaving systems often consist of a handle and a replaceable cartridge in which one or more blades are mounted in a housing. Various types of blades are known in the art, including linear blade edges found in typical shaving razors, as well as circular blades. After the blades in a cartridge have become dull from use, the cartridge is discarded and replaced on the handle with a new cartridge. These types of shaving systems that utilize a variety of connection schemes to affix the cartridge to the handle have become popular. The connection scheme allows the consumer to easily, repeatedly, efficiently, and intuitively load and remove the new and used cartridges from the handle and provides the necessary retention forces to maintain the integrity of the handle-to-cartridge attachment during shaving.

The connection scheme must be robust enough to provide the necessary retention forces to maintain the integrity of the handle-to-cartridge attachment during shaving. The attachment of a razor cartridge to razor handle can provide sufficient retaining force to secure the razor cartridge to the razor handle over a wide variety of shaving conditions. However, the attachment mechanisms are typically not intuitive and only allow for a specific orientation that allows proper attachment. In addition, such systems often include ejection mechanisms which can add cost and complexity.

There is a growing market for more premium handles, which are typically made from various metals, making the handles much heavier. The heavier handles provide a more pleasing feel in the consumers hand during shaving. Some consumers believe that heavier handles provide improved control during shaving. However, an increase in the handle weight increases the likelihood the attachment mechanism breaks if the handle is dropped. Accordingly, there is a need for a simpler, more robust, more intuitive, and reliable shaving handle-to-cartridge connection.

### SUMMARY OF THE INVENTION

In one aspect, the invention features, in general a shaving system with a handle having a distal end and a proximal end. A shaving cartridge assembly is mounted on the proximal end of the handle. The shaving cartridge assembly includes a shaving surface. A coupling interface between the shaving assembly and the handle. The coupling interface includes a first surface separable from a second surface. The first surface defines a rinse cavity. An appendage extends from the second surface and into the rinse cavity. The first surface is magnetically coupled to the second surface.

In another aspect, the invention features, in general a shaving system having a handle with a proximal end having a first surface that is circular and flat. The first surface defining a rinse cavity. A shaving cartridge assembly is mounted on the proximal end of the handle. The shaving cartridge assembly includes a shaving surface mounted to a housing. The shaving surface has a plurality of openings in communications with the rinse cavity. The shaving cartridge assembly is removably secured to the handle by a magnetic force between the first surface and a second surface on the housing of the shaving cartridge assembly.

In another aspect, the invention features, in general a handle for a shaving system with a proximal end and a distal end. The proximal end having a first surface that is circular and flat. A gripping portion is between the proximal end and the distal end. The first surface comprises at least one magnetic element.

In another aspect, the invention features, in general a handle for a shaving system with a proximal end and a distal end. The proximal end having a first surface defining a rinse cavity having an area of about 100 mm² to about 300 mm². A gripping portion is between the proximal end and the distal end. The gripping portion defines an opening in communication with the rinse cavity.

In another aspect, the invention features, in general a shaving cartridge assembly with a housing having a circular appendage defining a cavity extending through the housing. A shaving surface is mounted to the housing. A washer is mounted over the circular appendage and onto a flange of the housing. The washer is a ferromagnetic metal.

In another aspect, the invention features, in general a shaving cartridge assembly with a housing having an appendage defining a cavity extending through the housing. A shaving surface is mounted to the housing. The shaving surface has a plurality of openings in communication with the cavity. The appendage extends from a flange of the housing and the flange comprises a ferromagnetic metal.

### BRIEF DESCRIPTION OF THE DRAWINGS

Other features and advantages of the present invention, as well as the invention itself, can be more fully understood from the following description of the various embodiments, when read together with the accompanying drawings, in which:

FIG. 1 is an assembly view of a shaving system according to one possible embodiment of the present invention.

FIG. 2 is a bottom perspective view of a shaving cartridge assembly of the shaving system of FIG. 1.

FIG. 3 is bottom view of the shaving cartridge assembly of FIG. 2.

FIG. 4 is a cross sectional view of the shaving cartridge assembly, taken generally along the line 4-4 of FIG. 3.

FIG. 5 is an assembly view of the handle of the shaving system of FIG. 1.

FIG. 6 is a perspective view of the shaving system of FIG. 1.

FIG. 7 is a cross sectional view of the shaving system, taken generally along the line 7-7 of FIG. 6.

FIG. 8 is a bottom view of an alternative embodiment of a shaving cartridge assembly.

FIG. 9 is a cross section view, generally taken along the line 9-9 of FIG. 8.

FIG. 10 is a perspective view of a handle from FIG. 1.

### DETAILED DESCRIPTION OF THE INVENTION

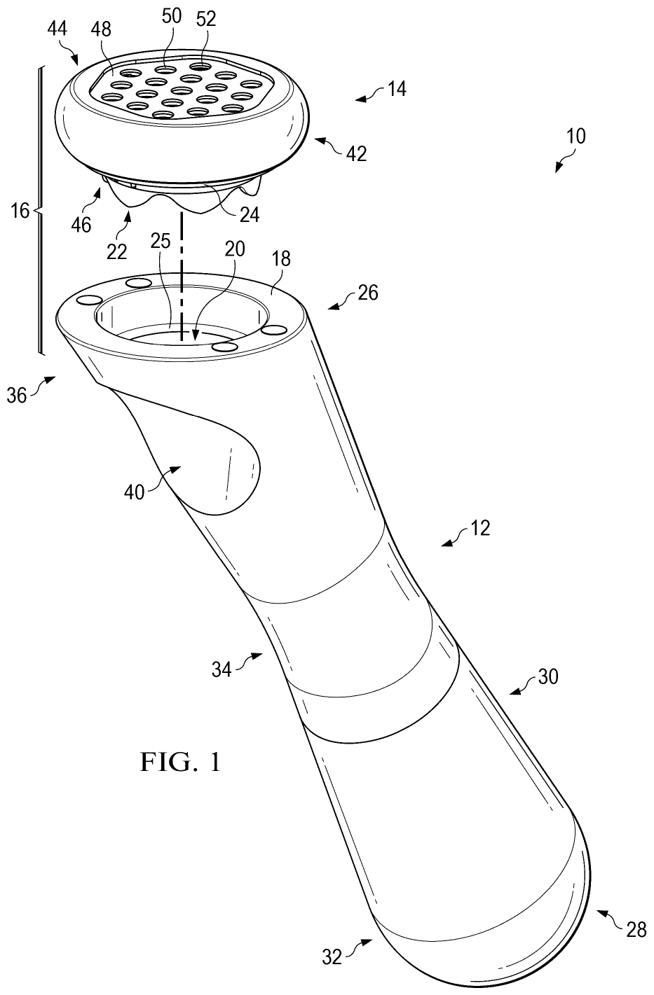

Referring to FIG. 1, a perspective view of a shaving system 10 is illustrated. The shaving system 10 may include a handle 12 and a shaving cartridge assembly 14. In certain embodiments, the shaving cartridge assembly 14 may be mounted to a top surface of the handle 12. The shaving cartridge assembly 14 may the component of the shaving system 10 that is replaced. The handle 12 may be made from any suitable material. For example, the handle 12 may be made from various metals, polymers, elastomers, rubbers, any other suitable material, or any combination thereof. It is understood that using more premium materials, such as metals, may increase the weight of the handle 12. The handle may be made, by molding, injection molding, insert injection molding, casting, extrusion, machining, or any combination thereof.

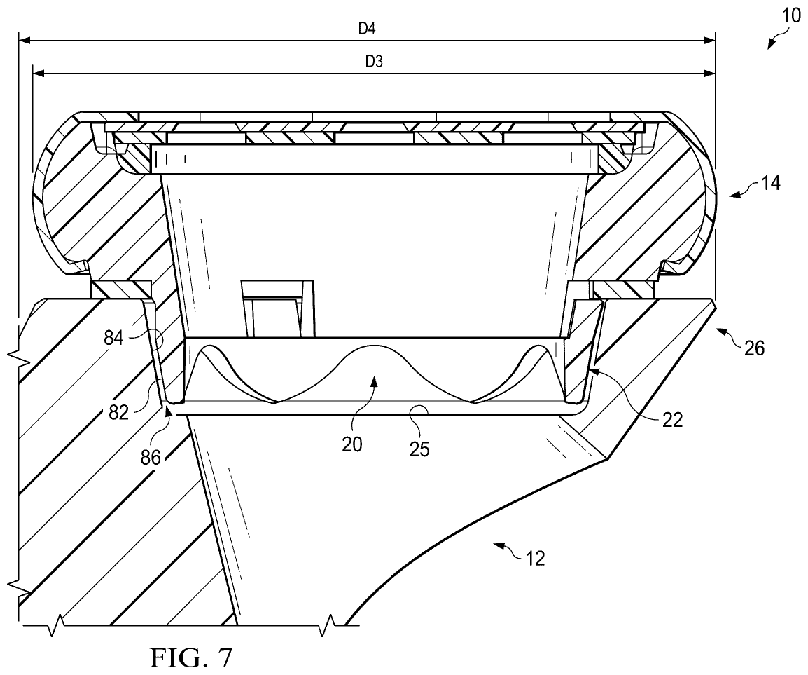

The shaving cartridge assembly 14 may be releasably attached to the handle 12. For example, FIG. 1 illustrates the shaving system 10 with the shaving cartridge assembly 14 detached from the handle 12. Accordingly, the shaving cartridge assembly 14 may be replaced after a desired number of uses is reached by a consumer. As will be described in greater detail below, the shaving razor system 10 may incorporate a coupling interface 16 between the handle 12 and the shaving cartridge assembly 14 to enable quick and intuitive attachment and removal of the shaving cartridge assembly 14 from the handle 12. The coupling interface 16 may include a first surface 18 defining a rinse cavity 20 and an appendage 22 extending into the rinse cavity 20. The handle 12 may include a ledge 25 positioned within the rinse cavity 20. The rinse cavity 20 may have an area of 100 mm² or greater as measured at the first surface 18. For example, the rinse cavity 20 may have an area of about 100 mm² to about 300 mm² or more preferably about 125 mm² 175 mm² to allow sufficient rinsing of shaving debris while allowing the shaving razor cartridge assembly 14 to be small enough to reach the area between the nose and mouth. In certain embodiments, a distance from the ledge 25 to the first surface may be about 3 mm to about 6 mm. The appendage 22 may be spaced apart from the ledge 25 to facilitate proper seating of the shaving razor cartridge assembly 14 on the first surface 18, for example, as shown in FIG. 7.

The appendage 22 may extend from a second surface 24 that is magnetically coupled to the first surface 18. Accordingly, the first surface 18 is separable from the second surface 24 when the magnetic attraction force is overcome. It is understood that portions of coupling interface 16 may be interchangeable between the handle 12 and the shaving cartridge assembly 14 to enable the shaving cartridge assembly 14 to be releasably attached to the handle 12. The coupling interface 16 may provide a sufficient magnetic force to draw the shaving cartridge assembly 14 onto the handle 12 and to retain the shaving cartridge assembly 14 on the handle 12 during shaving and when shaving is not taking place (e.g., between shaving strokes, during rinsing, and when the shaving system 10 is not in use). It is believed, without being held to theory, that a force of about 2 Newtons to about 10 Newtons, and more preferably about 3 Newtons to about 7 Newtons is sufficient to provide an optimal attraction force while also sufficient to prevent rotation of the shaving razor cartridge assembly 14 relative to the handle 12 during a shaving stroke. For example, the attraction force may be greater than the weight of the shaving razor cartridge assembly 14. In certain embodiments, the attraction force may facilitate the shaving razor cartridge assembly 14 to jump onto the handle 14. However, attraction force may be sufficiently low enough the shaving razor cartridge assembly 14 is easy for a consumer to remove from the handle 12. Furthermore, the shaving cartridge assembly 14 may be configured to rotate relative to the handle 12 prior to shaving. For example, a user may notice after repeated use in a particular handle 12 to the shaving razor cartridge assembly 14 orientation a wear pattern develops in a specific area of a shaving surface 48. Accordingly, the user can simply adjust the orientation of the shaving surface 48 by rotating the shaving cartridge assembly 14 (relative to the handle 12) by rotating the shaving razor cartridge assembly 14.

The handle 12 may have a proximal end 26, a distal end 28 and a gripping portion 30 between the proximal end 26 and the distal end 28. The distal end 28 may include an enlarged bulbous portion 32. The gripping portion 30 may taper from the enlarged bulbous portion 32 to a reduced mid portion 34. The gripping portion 30 may also taper from the reduced mid portion 34 to an enlarged proximal end portion 36 resulting in an hourglass shape. The enlarged proximal end portion 36 may define an opening 40. The opening 40 may be generally perpendicular to the rinse cavity 20. In certain embodiments, the proximal end 26 of the handle may include the first surface (e.g., top surface) 18. The first surface 18 may be flat (e.g., no protrusions or walls extending therefrom which may limit rotation of the shaving cartridge assembly 14) and have a generally circular shape. As will be described in greater detail below, the first surface 18 geometry may allow for the shaving cartridge assembly to rotate relative to the handle 12. The rinse cavity 20 defined by the first surface 18 may extend to the opening 40. Accordingly, the rinse cavity 20 is in communication with the opening 40 to enable water and shaving debris to be rinsed out from the handle 12 and the shaving cartridge assembly 14.

The shaving cartridge assembly 14 may include a housing 42 having a proximal end 44 and a distal end 46. A shaving surface 48 may be mounted to the housing 42 (e.g., at the proximal end 44). The shaving surface 48 may be used for removal of hair or skin (e.g., exfoliation). In certain embodiments, the shaving surface 48 may include a plurality of circular cutting edges 50, each defining a respective opening 52 to facilitate the removal of shaving debris and water. The circular cutting edges 50 may allow a hair to be cut when it extends into the associated opening 52. Since the circular cutting edges 50 encircle the opening 52, a hair may be cut when shaving surface 48 passes over hairs in any direction, allowing for multi-directional hair cutting. The cutting of hair in multiple directions may eliminate the need to have a specific orientation of the handle 12 relative to the shaving cartridge assembly 14, which may simplify attachment. In certain embodiments, the housing 42 may include the appendage 22 at the distal end of the housing 42. The appendage 22 may be configured to be received within the rinse cavity 20. The appendage 22 may facilitate attachment and alignment the shaving cartridge assembly 14 to the handle 12. For example, a user may align the appendage 22 with the rinse cavity 20. In certain embodiments, the appendage 22 and the rinse cavity 20 may be circular. Accordingly, no specific orientation or rotation is needed to align the appendage 22 with the rinse cavity 20. The first surface 18 may be rotatable relative to the second surface 24 to facilitate rotation of the shaving cartridge assembly 14 relative to the handle 12. For example, the appendage 22 can be attached to the handle 12 in 360 degrees. A keying type of design may cause consumer confusion and frustration as the consumer would need to align certain features on a handle with other features on a cartridge. The shaving surface 48 (and circular cutting edges 50) may be manufactured out of various metals, such as stainless steel or ceramic materials, such as silica or crystals like silicon, sapphire, or diamond.

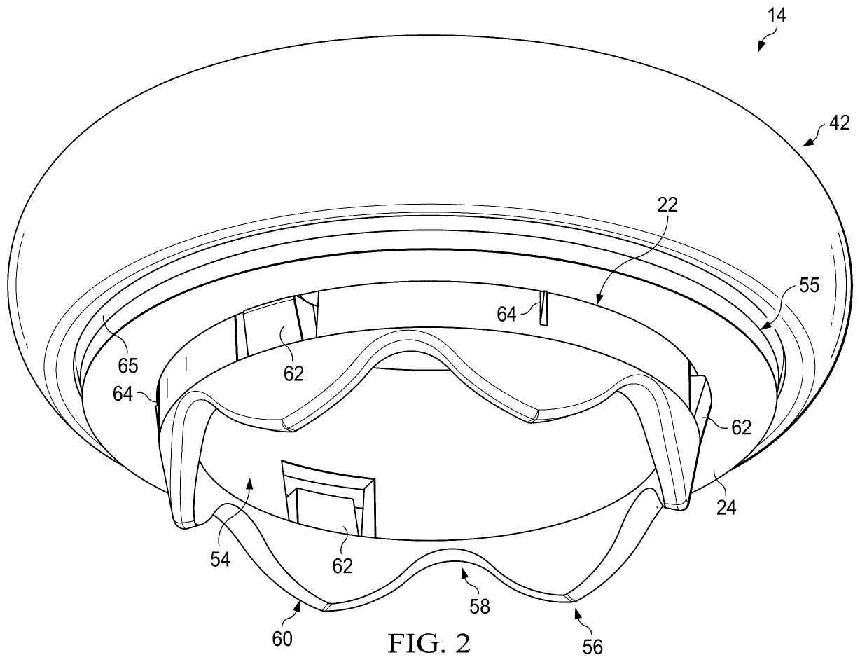

Referring to FIG. 2, a bottom perspective view of the shaving cartridge assembly 14 of FIG. 1 is illustrated. The appendage 22 may be generally circular in shape and define a cavity 54 that is in communication with the openings 52 of the circular cutting edges 50 (FIG. 1). The appendage 22 may extend beyond the second surface 24 to a distal end 56. In certain embodiments, the cavity 54 may be funnel shaped such that the cavity 54 tapers from a greater area toward the shaving surface 48 to a smaller area toward the distal end 56. The cavity may have an area at the distal end of about 100 mm² to about 300 mm² or more preferably about 125 mm² 175 mm² to facilitate the flow of water and the rinsing of the shaving cartridge assembly 14. The distal end 56 may optionally have a plurality of troughs 58 and crests 60. However, it is understood the distal end 56 may be generally flat. In certain embodiments, the housing 42 of the shaving cartridge assembly 14 may comprise a ferromagnetic material (e.g., the second surface 24). For example, second surface 24 may be a ferromagnetic material part of the housing 42 or a washer 55 (having ferromagnetic properties) mounted over the appendage 22 and on to a flange 65 of the housing 42. The appendage 22 may extend about 2.5 mm to about 5.5 mm from the flange 65 to the distal end 56 to allow sufficient engagement within the rinse cavity 22 of FIG. 1. For example, if the appendage 22 is too short, the shaving cartridge assembly 14 may be easily knocked off the handle 12. The washer 55 may have a thickness of about 0.25 mm to about 0.6 mm. The washer 55 may have an inner diameter of about 10 mm to about 18 mm. The washer 55 may have an outside diameter of about 16 mm to about 24 mm. The dimensions of the washer 55 may provide for more efficient magnetic attachment within a limited area.

The washer 55 may provide the second surface 24 to extend in a continuous manner around the appendage 22. Accordingly, no alignment may be necessary compared to one or more ferrimagnetic elements having gaps therebetween. The second surface 24 (e.g., washer 55) may exhibit a magnetic property or combination of magnetic properties. For example, the second surface 24 (e.g., washer 55) may include a permanent magnet, a dipole magnet, an electromagnet, a ferromagnetic material, a magnetized ferromagnetic material, a positive pole, a negative pole, or any combination thereof. The second surface 24 (e.g., washer 55) may, for example, be a magnetic element that exerts an attractive magnetic force. The second surface 24 (e.g., washer 55) may be, for example, a magnetic element that is attracted by a magnetic force. The second surface 24 (e.g., washer 55 may be of any suitable material that exhibits at least one of aforementioned magnetic properties. The second surface 24 (e.g., washer 55) may, for example, comprise at least one of iron, nickel, aluminum, cobalt, boron, alnico, ferrite, gadolinium, dysprosium, samarium, samarium-cobalt, neodymium-iron-boron, any alloy thereof, any ceramic thereof, or any combination thereof. In addition, the second surface 24 (e.g., washer 55) may be plated or coated (e.g., with plastic, rubber or nickel) to resist corrosion caused by the shaving environment.

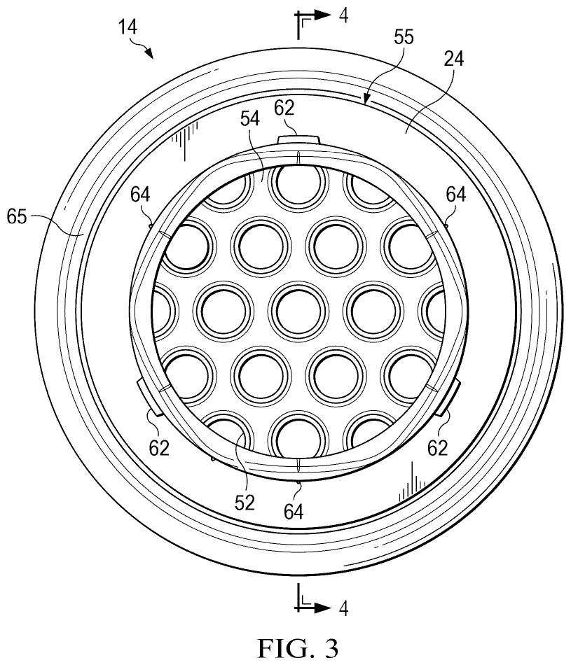

Referring to FIGS. 2 and 3, the appendage 22 may have a plurality of circumferentially extending tabs 62 (e.g., undercut surfaces). For example, the appendage 22 may include three equally spaced apart tabs 62 to facilitate the attachment of the washer 55. The tabs 62 may flex during assembly to facilitate securing the washer 55 to the appendage 22 (e.g., the flange 65). The washer 55 may be slipped over the appendage 22 during assembly, and then snap over the tabs 62, locking the washer 55 in place. The washer 55 may be secured between the flange 65 and the plurality of tabs 62. In certain embodiments, one or more crush ribs 64 may be provided on the appendage 22 to provide an interference fit between the washer 58 and the appendage 22. The crush ribs 64 may aid in preventing the washer 55 from rotating relative to the appendage 22 during use. One or more of the crush ribs 64 may be provided between adjacent tabs 62. The tabs 62 may be spaced apart along a perimeter of appendage by about 100 degrees to 140 degrees. The crush bumps 64 may have a depth of about 0.1 mm to about 0.5 mm provide for an interference fit between the washer 58 and the appendage 22.

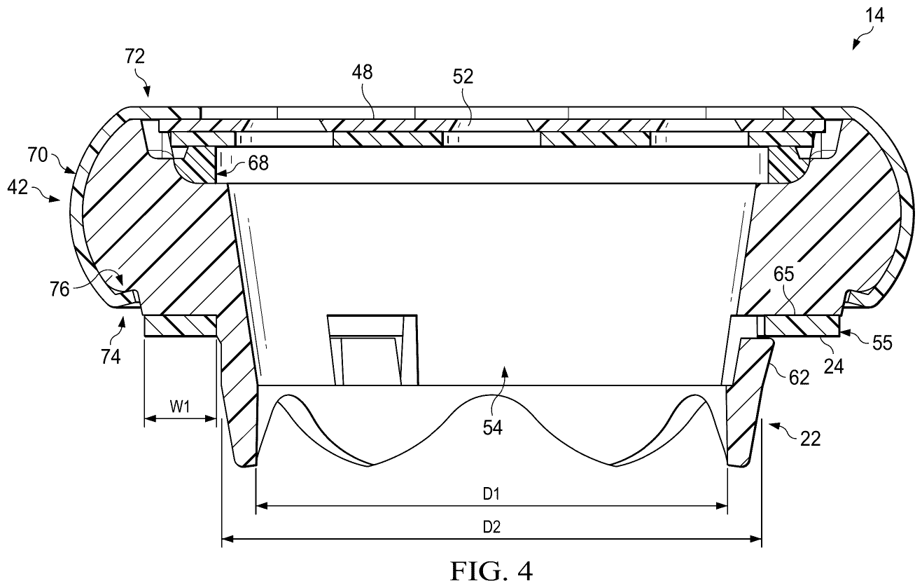

Referring to FIG. 4, a cross sectional view of the shaving cartridge assembly 14, taken generally along the line 4-4 of FIG. 3 is illustrated. The flange 65 may provide a flat surface for the washer 55 to be mounted to. The flange 65 may have a width “w1” of about 1.0 mm to about 4.0 mm to accommodate the washer 55. For example, the washer 55 may have approximately the same width as the flange 65. The crush ribs 64 (FIG. 2) may better accommodate for tolerance stack up between the inner diameter of the washer 55 and the outer diameter of the appendage 22. Accordingly, a gap may exist between portions of the washer 58 and the appendage 22, such as areas without crush ribs 64 (FIG. 2). For example, during assembly, the washer 55 may slide freely over the appendage 22 prior to reaching the crush ribs 64 (FIG. 2). The washer 55 may be fully seated against the flange 65 by forcing the washer 55 over the crush ribs 64 (FIG. 2), thus deforming the crush ribs 64. In addition, during assembly, the washer 55 may deflect the tabs 62 inward. Once the washer 55 slides past the tabs 62, the tabs 62 may flex back into position to secure the washer 55 in an axial direction. The washer 55 may be captured between the tabs 62 and the flange 65. It is understood that the washer 55 (and second surface 24) of the coupling interface 16 for magnetic attraction (FIG. 1), may be incorporated as part of the housing 42. For example, the housing 42 and/or flange 65 may comprise a ferromagnetic material. In certain embodiments, a plurality of magnetic elements may be positioned along the flange 65.

The shaving surface 48 may be mounted to a gasket 68. In certain embodiments, the shaving surface 48 may be directly mounted to the gasket 68 and the gasket 68 may be directly mounted to the housing 42. The gasket 68 may be a separate component, such as an O-ring, that is mounted to the housing 42 or the gasket 68 may be co-injection molded as part of the housing 42. The gasket 68 may comprise an elastomeric material, such as silicones, or various rubbers. A clip 70 may secure the shaving surface 48 to the housing 42. The shaving surface 48 may be positioned between the gasket 68 and the clip 70. The gasket 68 may facilitate preloading the shaving surface 48 to an underside of the frame 70. The gasket 68 may also act as a shock absorber to provide protection during an accidental drop of the product, thus minimizing damage to the shaving surface 48 and/or the circular cutting edges 50. This may be especially important, for example, if the shaving surface 48 and/or the circular cutting edges 50 are made from brittle materials such as ceramics.

The clip 70 may have a first end 72 mounted over a portion of the shaving surface 48 and a second end 74 crimped over a rim 76 of the housing 42 and angled toward the first end 72 to preload the shaving surface 48 against the gasket 68. The flange 65 may be located on the housing 42 between the rim 76 and the appendage 22. In certain embodiments, the rim 76 may extend circumferentially around the housing 42. Similarly, the second end 74 may also extend circumferentially around the rim 76 to reduce sharp edges and provide a stronger assembly.

As shown in FIG. 4, the appendage 22 may have an inner diameter “D1” of about 10 mm to about 17 mm. The diameter “D1” may allow for fast and easy washing out of the cavity 54 and the openings 52 that are in communication with the cavity 54. The inner diameter D1 may taper from a smaller dimension toward the distal end 56 (FIG. 2) to a larger diameter toward the shaving surface 48. The appendage 22 may also have an outer diameter “D2” measured at the washer 55 (e.g., the second surface 24) of about 12 mm to about 18 mm. The outer diameter “D2” may facilitate insertion of the appendage 22 into the rinse cavity 20 of the handle 12 (FIG. 1).

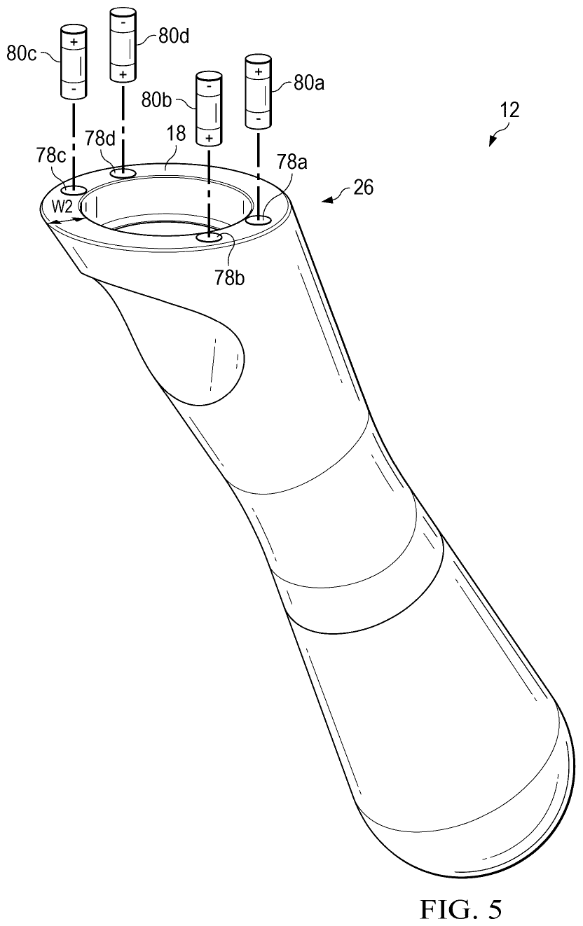

Referring to FIG. 5 a perspective view of the handle 12 of the shaving system 10 of FIG. 1 is illustrated. In certain embodiments, the first surface 18 may be located at the proximal end 26 of the handle 12. The first surface 18 may define one or more pockets 78a, 78b, 78c and 78d dimensioned to receive a respective magnetic element 80a, 80b, 80c and 80d. The magnetic elements 80a, 80b, 80c and 80d may have a diameter of about 1 mm to about 2 mm to provide a sufficient magnetic force but also fit within an area of the first surface 18. The first surface 18 may be large enough for sufficient magnetic attraction, but small enough to provide proper ergonomics for the shaving cartridge assembly 16 and the shaving razor system 10 (FIG. 1), while also maximizing the size of the rinse cavity 20. For example, the first surface 18 may have a width “w2” of about 1.5 mm to about 4 mm to accommodate the pockets 78a, 78b, 78c and 78d and the magnetic elements 80a, 80b, 80c and 80d without weakening handle 12. If the pockets 78a, 78b, 78c and 78d are too large and/or the width of the first surface 18 is too small, the handle 12 may crack or break if it is dropped. In certain embodiments, the first surface 18 may have an area of 100 mm² or greater. For example, the first surface 18 may have an area of about 100 mm² to about 300 mm² or more preferably about 125 mm² 175 mm² to allow a sufficient to receive the magnetic elements 80a, 80b, 80c and 80d, as well as support the shaving razor cartridge assembly 14. It has been determined that the size of the magnetic elements 80a, 80b, 80c and 80d (and thus the pockets 78a, 78b, 78c and 78d) can be minimized by orienting a polarity of the magnetic elements 80a, 80b, 80c and 80d relative to each other to increase the magnetic force. For example, two adjacent magnetic elements 80a and 80b may have opposing polarity. For example, the magnetic element 80a may have its negative pole positioned on the first surface 18 of the handle 12 and the magnetic element 80b may have its positive pole on the first surface of the handle 12. The positive pole of the magnetic element 80a may be positioned within the pocket 78a and the negative pole of the magnetic element 80b may be positioned within the pocket 78b. Similarly, the two adjacent magnetic elements 80c and 80d may also have opposing polarity. For example, the magnetic element 80c may have its positive pole positioned on the first surface 18 of the handle 12 and the magnetic element 80d may have its negative pole on the first surface of the handle 12. The positive pole of the magnetic element 80d may be positioned within the pocket 78d and the negative pole of the magnetic element 80c may be positioned within the pocket 78c. The magnetic elements 80c and 80b may also have opposing polarities and the magnetic elements 80d and 80a may also have opposing polarities. This orientation of magnetic elements and polarity result in the generation of a stronger magnetic force and thus reduces the size of the magnetic elements required. Although four magnetic elements 80a, 80b, 80c and 80d are shown, it is understood more magnetic elements may be added if larger attractive forces are required. For example, six or more magnetic elements may be placed along the first surface 18 to provide for an even greater magnetic force.

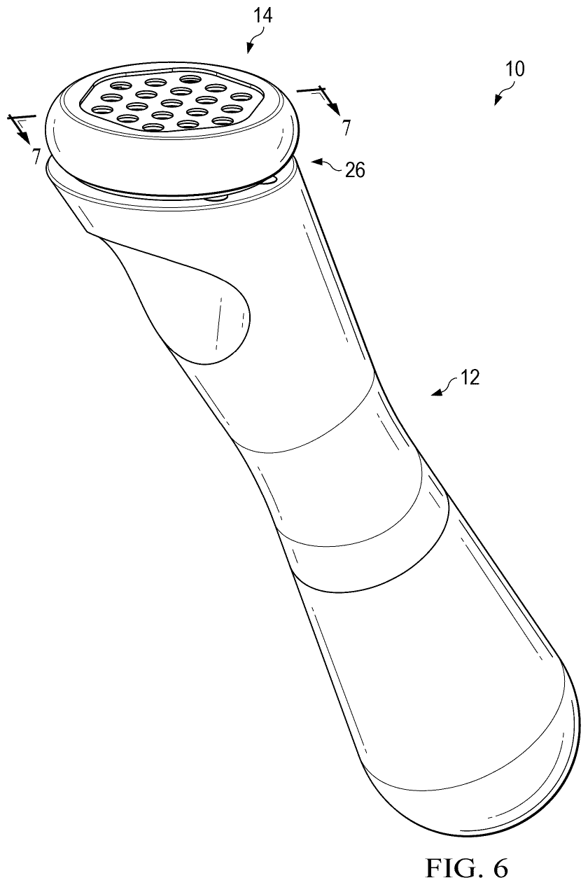

Referring to FIGS. 6 and 7, a perspective view of the shaving system 10 and a cross sectional view of the shaving system 10, taken generally along the line 7-7 of FIG. 6 are illustrated, respectively. In certain embodiments, a diameter D3 of the shaving cartridge assembly 14 may be the approximately (e.g., within 10% to 15%) of a diameter D4 of the first end 26 of the handle 12 (e.g., the first surface 18). If the shaving cartridge assembly 14 extends too far over the proximal end 26 of the handle 12, a user may accidently knock off or remove the shaving cartridge assembly 14 from the handle 12. In certain embodiments, an outer wall 82 of the appendage 22 may be spaced apart from an inner wall 84 that defines the rinse cavity 20 to provide a gap 86 between the appendage 22 and the handle 12. Accordingly, the appendage 22 may fit within the rinse cavity 20 with no mechanical engagement of the inner wall 84 to allow for easy insertion and removal of the shaving razor cartridge assembly 14. However, it is understood the inner wall 84 may provide support and contact the appendage 22 during use, as the shaving cartridge assembly 14 may move slightly.

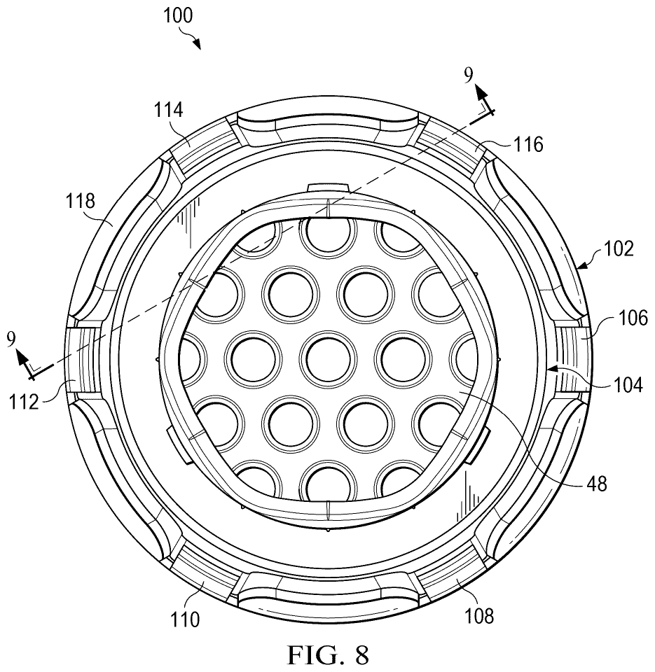

Referring to FIG. 8, a bottom view of an alternative embodiment of a shaving cartridge assembly 100 is shown. The shaving cartridge assembly 100 of FIG. 8 may be substantially the same as the shaving cartridge assembly 14 of FIGS. 1-7, with the exception of a modified clip 102 and housing 104. The clip 102 may have a plurality of tabs 106, 108, 110, 112, 114 and 116 to secure the shaving surface 48 to the housing 104. The tabs 106, 108, 110, 112, 114 and 116 may provide securement of the shaving surface 48 to the housing 104 without negatively impacting the aesthetics of a smooth round outer surface 118 of the clip 102. A single crimp type design, such as the clip 70 of FIGS. 1-7 may cause wrinkling of the outer surface of the clip 70.

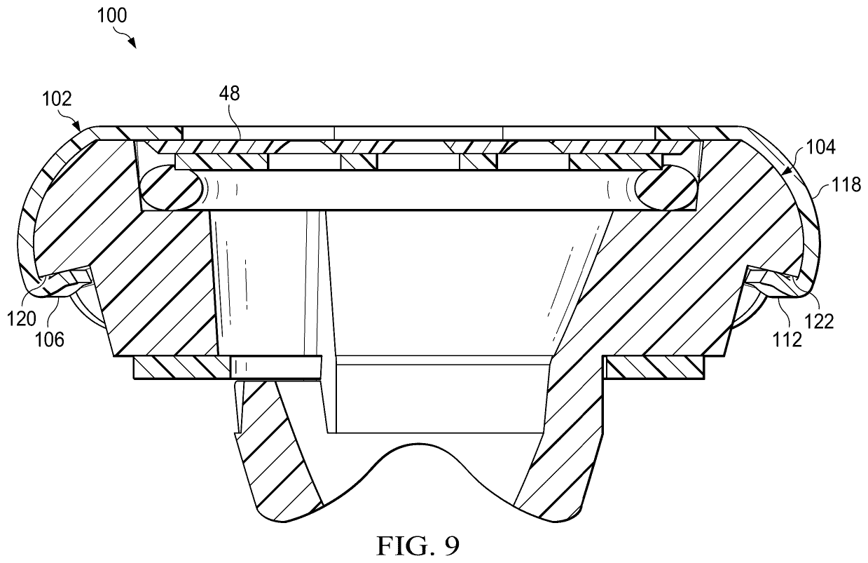

Referring to FIG. 9, a cross section view is shown, generally taken along the line 9-9 of FIG. 8. The clip 102 may be mounted over a portion of the shaving surface 48. Accordingly, the shaving surface 48 may be positioned between the clip 102 and housing 104 The tabs 106, 108, 110, 112, 114 and 116 (tabs 106 and 112 shown in FIG. 9) may be crimped over a respective lower surface 120 and 122 of the housing 104. The lower surfaces 120 and 122 may extend outwardly toward the outer surface 118 of the clip 102 and down and away from the shaving surface 48 to facilitate more secure crimping of the tabs 106, 108, 110, 112, 114 and 116 to the housing 104.

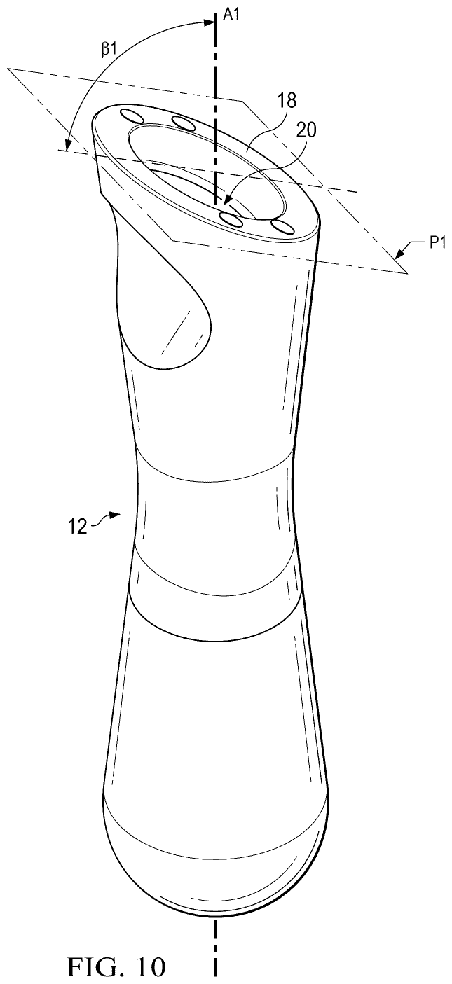

Referring to FIG. 10, a perspective view of the handle 12 is illustrated. In certain embodiments, the first surface 18 of the handle 12 may extend along a first plane P1. The first plane P1 and a center axis A1 of the handle 12 may define an angle that is less than 90 degrees, for example, about 30 degrees to about 80 degrees. The slope of the first surface 18 relative to the center axis A1 of the handle 12 may not only provide for a more optimum angle for the consumer to hold the shaving system 10 (FIG. 1) against the surface of the skin (e.g., the face and neck), but may also provide for improved visibility when attaching the shaving cartridge assembly 12 (FIG. 1) to the handle 14. In certain embodiments, the center axis A1 of the handle 12 may be generally aligned with the rinse cavity 20 (e.g., a center axis of the rinse cavity may be generally aligned with the center axis A1 of the handle 12, which may provide more precision and control of the handle 12, especially round the mouth and nose areas of the face. In certain embodiments, less pressure may be desired during shaving, especially when shaving fine, short hair vellus hair, which may require less pressure. The skin of female user may be more sensitive to shaving pressure because they do not shave as frequently as men, thus greater control of the pressure the handle 12 exerts may be important.

While shaving systems are described above, it is noted that the magnetic engagement and/or the mechanical engagement described herein could be used in any suitable consumer product system, including but not limited to consumer products, personal hygiene products (e.g., a toothbrush or hairbrush), reusable shaving systems, interchangeable depilatory systems, and grooming systems. It should also be understood that shaving system 10 shown in FIG. 1 is for illustrative purposes only and that any other shaving system or hair-removing system or subsystem could be used in conjunction with or in lieu of system. Preferred shaving systems are safety razors with a replaceable cartridge-type blade scheme.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.” Furthermore, dimensions should not be held to an impossibly high standard of metaphysical identity that does not allow for discrepancies due to typical manufacturing tolerances. Therefore, the term “about” should be interpreted as being within typical manufacturing and measuring tolerances.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A shaving cartridge assembly comprising:
a housing with a circular appendage defining a cavity extending through the housing;
a shaving surface mounted to the housing;
a washer mounted over the circular appendage and onto a flange of the housing, wherein the washer comprises a ferromagnetic metal.

2. The shaving cartridge assembly of claim 1 wherein the appendage comprises a plurality of tabs wherein the washer is secured between the flange and the plurality of circumferentially extending tabs.

3. The shaving cartridge assembly of claim 2 wherein the plurality of tabs are spaced apart by about 100 degrees to 140 degrees.

4. The shaving cartridge assembly of claim 1 wherein at least one crush bump is positioned between the washer and the appendage.

5. The shaving cartridge assembly of claim 1 wherein a plurality of crush bumps positioned between the washer and the appendage.

6. The shaving cartridge assembly of claim 4 wherein the crush bump has a depth of about 0.1 mm to about 0.3 mm.

7. The shaving cartridge assembly of claim 1 wherein the washer has a thickness of about 0.3 mm to about 0.7 mm.

8. The shaving cartridge assembly of claim 1 wherein the washer has a width of about 1.0 mm to about 4.0 mm.

9. The shaving cartridge assembly of claim 1 wherein the shaving surface comprises a plurality of circular cutting edges that each define an opening.

10. The shaving cartridge assembly of claim 9 wherein the openings are in communication with the cavity.

11. The shaving cartridge assembly of claim 1 wherein the flange has a width of about 1.0 mm to about 4.0 mm.

12. The shaving cartridge assembly of claim 1 wherein the appendage has an inner diameter of about 10 mm to about 17 mm.

13. The shaving cartridge assembly of claim 1 further comprising a gasket mounted to the housing and the shaving surface is mounted to the gasket.

14. A shaving cartridge assembly comprising:
a housing with an appendage defining a cavity extending through the housing;
a shaving surface mounted to the housing, the shaving surface having a plurality of openings in communication with the rinse cavity, wherein the appendage extends from a flange of the housing and the flange comprises a ferromagnetic metal.

15. The shaving cartridge assembly of claim 14 wherein a distance from the flange to a distal end of the appendage is about 2.5 mm to about 5.5 mm.

16. The shaving cartridge assembly of claim 14 further comprising a gasket mounted to the housing and the shaving surface is mounted to the gasket.

17. The shaving cartridge assembly of claim 16 further comprising a clip having a first end mounted over a portion of the shaving surface and a second end crimped over a rim of the housing and towards the first end.

18. The shaving cartridge assembly of claim 17 wherein the second end extends circumferentially around the rim.

19. The shaving cartridge assembly of claim 14 wherein the appendage is circular and has an outer diameter of about 12 mm to about 18 mm.

20. The shaving cartridge assembly of claim 14 wherein the shaving surface comprises a plurality of circular cutting edges that each define an opening in communication with the cavity.
